(19) United States
(12) Patent Application Publication
(10) Pub. No.: US 2023/0087703 A1
(43) Pub. Date: Mar. 23, 2023

(54) NATURAL SMOKE FLAVOR WITH ANTIOXIDANT PROPERTIES FOR USE IN PET FOODS AND/OR PET FOOD INGREDIENTS

(71) Applicants: Kerry Group Services International Limited, Kerry (IE); CFS North America, LLC, Urbandale, IA (US)

(72) Inventors: Mark Van Der BLEEK, Cookeville, TN (US); Jennifer IGOU, West Des Moines, IA (US); S.P. Janaka Namal SENANAYAKE, Waukee, IA (US)

(73) Assignees: Kerry Group Services International Limited, Kerry (IE); CFS North America, LLC, Urbandale, IA (US)

(21) Appl. No.: 17/950,700

(22) Filed: Sep. 22, 2022

Related U.S. Application Data
(60) Provisional application No. 63/247,568, filed on Sep. 23, 2021.

(51) Int. Cl. A23K 30/00; A23K 50/40; A23K 10/20

(52) U.S. Cl. CPC A23K 30/00; A23K 50/40; A23K 10/20

(57) ABSTRACT

A natural antioxidant for pet food and/or pet food ingredients to extend the shelf life of the pet food and/or pet food ingredients. The natural antioxidant is a natural smoke antioxidant obtained from fractions of natural liquid smoke. A pet food or pet food ingredient that contains a phenolic fraction of a liquid natural smoke flavor (or “the natural smoke extract”). The phenolic fraction exhibits an antioxidant effect on the pet food or the pet food ingredient, such as delayed oxidation or hydrolysis of fats and oils, whereas fats include animal fat and oils include vegetable oils; or stated differently, the delayed rancidification of the pet food or pet food ingredient.

### FIELD OF THE DISCLOSURE

A purpose of the present disclosure is to provide, for example, a natural antioxidant for pet food and/or pet food ingredients to extend the shelf life of the pet food and/or pet food ingredients, wherein the natural antioxidant is a natural smoke antioxidant obtained from fractions of natural liquid smoke. In one aspect, the disclosure provides a pet food or pet food ingredient that contains a phenolic fraction of a liquid natural smoke flavor (referred to herein, for example, as “the natural smoke extract”), where the phenolic fraction exhibits an antioxidant effect on the pet food or the pet food ingredient (e.g., the delayed oxidation or hydrolysis of fats and oils, whereas fats include animal fat and oils include vegetable oils, or stated differently, the delayed rancidification of the pet food or pet food ingredient). In one aspect, while the disclosure may refer to pet food and pet food ingredients, the use of the natural smoke antioxidant of the disclosure extends to animal feed and animal feed ingredients (thus, the terms “pet food” and “pet food ingredients” are used for convenience and broadly refer to animals and animal feed generally, unless specifically stated otherwise, as would be understood by persons of ordinary skill in the art).

### BACKGROUND OF THE DISCLOSURE

Pet food and pet food ingredients are very susceptible to oxidation, resulting in deterioration of quality due to rancidity and formation of other oxidative by-products.

Historically, pet food and pet food ingredients contain synthetic antioxidants, such as BHA, BHT, TBHQ, propyl gallate, and ethoxyquin. Although synthetic antioxidants may be very effective, this results in undesirable labelling declarations.

More recently, pet food and food ingredients may contain natural extracts and/or botanicals, such as, for example, mixed tocopherols and rosemary or green tea, to achieve “clean label” declarations while maintaining a level of antioxidant performance. However, these natural ingredients can be costly and may have challenges with stability in both high temperature extremes and low temperature extremes in a pet food system. Thus, for example, it is generally necessary to repeatedly add additional amounts of the natural antioxidant over time during each step of the manufacturing process, such as, for example, prior to rendering, during rendering, after rendering, and in the mixture providing the final pet diet.

Natural smoke flavor has been utilized in food as a “flavor” and/or “aroma” enhancer, such as, for example, in meat, fish, sauces, soups, spices, pet food, and pet treats. However, prior to the present disclosure, natural smoke flavor was not used, and was not envisioned for use as, an antioxidant in these applications.

Accordingly, there exists a need for a natural antioxidant for pet food or a pet food ingredient that, for example, may address one or more of the problems noted above; that can be used in place of a synthetic antioxidant; and that meets the requirements for clean label directions, while also providing a product having satisfactory organoleptic properties for pets, other animals, and/or for humans.

### SUMMARY OF THE DISCLOSURE

In one aspect, the present disclosure provides a natural smoke antioxidant that includes a phenolic extract from liquid natural smoke (the natural smoke extract). In other words, the present disclosure provides a natural smoke antioxidant that includes the natural smoke extract. In some aspects, the natural antioxidant consists essentially of the natural smoke extract. In some aspects, the natural smoke antioxidant consists of the natural smoke extract. In other words, the natural smoke antioxidant may be substantially or entirely the natural smoke extract, or the natural smoke antioxidant may include other components in addition to the natural smoke extract.

In the present disclosure, an antioxidant has a function of delaying oxidation or hydrolysis of fats and oils in meat or meat products, thereby delaying rancidification of the pet food or pet food ingredient.

In one aspect, the present disclosure provides a pet food or pet food ingredient containing the natural smoke antioxidant. In one aspect, the only antioxidant added to the pet food or pet food ingredient is the natural smoke antioxidant.

In one aspect, the pet food or pet food ingredient includes a sufficient amount of the natural smoke extract to provide the antioxidant effects without the addition of any other antioxidant.

In one aspect, the pet food or pet food ingredient contains about 0.001% by weight to about 2% by weight of the natural smoke extract based on a total weight of the pet food or pet food ingredient.

In one aspect, the pet food or pet food ingredient contains the natural smoke antioxidant in an amount such that an amount of the natural smoke extract in the pet food or pet food ingredient is about 100 ppm to 10000 ppm

In one aspect, the pet food or pet food ingredient contains the natural smoke antioxidant in an amount such that an amount of the natural smoke extract in the pet food or pet food ingredient is about 200 ppm to 5,000 ppm.

In one aspect, the pet food or pet food ingredient may include, for example, rendered fats and oils, animal protein meals, vegetable oils, vitamin and/or trace mineral premixes, pet food kibbles, pet treats, and animal feed. In the present disclosure, the animal protein is not limited, and may refer to any animal protein presently used for manufacturing pet food and animal feed, including, for example, pork, veal, lamb, chicken, turkey, beef, fish, and the like.

In the present disclosure, the intended pet is not particularly limited, and may refer to any domestic or tamed animal kept for companionship or pleasure. Further, in terms of animal feed, the intended animal is not particularly limited, and may refer, for example, to any livestock animal raised in an agricultural setting to produce labor and/or commodities, such as, for example, meat, eggs, milk, fur, leather, and wool.

In one aspect, the present disclosure provides a method of reducing oxidation of pet food or a pet food ingredient by adding the natural smoke antioxidant to the pet food or pet food ingredient. In one aspect of this method, the only antioxidant added to the pet food or pet food ingredient is the natural smoke antioxidant.

In one aspect, the natural smoke extract may be a composition obtained from the pyrolysis of biomass (such as, for example, the pyrolysis of wood or plant material, such as, for example, hardwood sawdust) by a known method for producing liquid smoke flavor. The phenolic fraction may be separated from the other components of the natural smoke flavor to provide a composition rich in the phenolic fraction. The phenolic fraction may contain many phenolic compounds, such as, but not limited to, 2-methoxyphenol (guaiacol), 2,6-dimethoxyphenol, 3,4-dimethoxy-4-hydroxytoluene/Vanillic acid, Creosol, Ethanone, 1-(2,6-dihydroxy-4-methoxyphenyl), Furfural, 4-ethyl-2-methoxyphenol, 2,6-dimethoxy-4-(2-propenyl)-phenol, 9-Actadecenoic acid (Z)-, 2,3-bis(acetyloxy)propyl ester, 3-methylphenol (m-cresol).Prior to the present disclosure, it was never envisioned that the phenolic fraction of liquid, natural smoke flavor could be utilized as a partial or total replacement to conventional synthetic and natural antioxidants to produce pet food or a pet food ingredient (e.g., protein meal, fat, vitamin pre-mix, finished pet food).

In one aspect, the natural smoke antioxidant may include, for example, 5 to 50 mg/ml of the phenolic fraction. In other aspects, the amount of the phenolic fraction may be, for example, 10 to 50 mg/ml, 20 to 50 mg/ml, or 20 to 40 mg/ml.

In one aspect, the natural smoke extract is oil, lipid, or fat soluble, because the phenolic fraction is oil, lipid, or fat soluble. In contrast, liquid natural smoke flavor is generally water soluble, as the main fractions may be, for example, hydrophilic carbonyls and organic acids. In typical liquid natural smoke flavor, the phenolic fraction is generally a minor component that may be suspended in the liquid.

The natural smoke extract of the present disclosure was found to maintain its solubility in hydrophobic media, including, for example, animal fats and vegetable oils. For example, Oxidative Stability Index (OSI) and storage stability test results of the natural smoke extract in animal fats and vegetable oils were found to be excellent, and thus OSI was tested for on the pet food of the present disclosure containing the natural smoke extract.

In one aspect, the natural antioxidant of the present disclosure may include a combination of the natural smoke extract in mixture with one or more of additional components, including, for example, mixed tocopherols, rosemary extract, green tea, acerola extract, acetylated monoglycerides (as an example carrier or incidental additive), vegetable oil, silicon dioxide, and citric acid. For example, tocopherols and/or rosemary extract may be added for their antioxidant effect, and citric acid or ascorbic acid (vitamin C) may be added as an oxygen sequestering agent.

In one aspect, the separation of the natural smoke flavor to obtain the phenolic extract may be done via liquid/liquid extraction with a suitable extractant or a variety of other known processes for performing this function.

In one aspect, the natural smoke antioxidant may be combined with the pet food and/or the pet food ingredient resulting in increased shelf life of the pet food and/or the pet food ingredient.

In one aspect, the use of the natural smoke antioxidant provides a pet food or pet food ingredient that does not contain another antioxidant (such as, for example, BHA, BHT, propyl gallate, ethoxyquin, rosemary extract, green tea, sage extract, Vitamin E, mixed tocopherols, etc.).

In one aspect, the natural smoke antioxidant has stability at relatively high temperatures, such as, for example, about 40 degrees C. to about 150 degrees C., and/or stability at relatively low temperatures, such as, for example, about 10 degrees C. to about -20 degrees C. This means, for example, that the pet food or pet food ingredient containing the natural smoke antioxidant retains sufficient antioxidant properties at the relatively high and/or relatively low temperatures.

The relatively high and low temperatures may be experienced by the pet food or pet food ingredient during manufacture, storage, transportation, etc. of these products.

In one aspect, the natural smoke antioxidant provides similar shelf life for the pet food or pet food ingredient as conventionally used synthetic and natural antioxidants. In one aspect, the natural smoke antioxidant provides improved shelf life for the pet food or pet food ingredient as compared to conventionally used synthetic and natural antioxidants.

In one aspect, the natural smoke antioxidant imparts an aroma to the pet food or pet food ingredient that is considered pleasing to humans.

In some aspects, the pet food or pet food ingredient containing the natural smoke antioxidant may be more pleasing in its aroma to a human than the same pet food or pet food ingredient containing a conventional antioxidant.

In one aspect, the natural smoke antioxidant imparts an aroma and/or flavor to the pet food or pet food ingredient that is satisfactory to the pet.

In some aspects, the pet food or pet food ingredient containing the natural smoke antioxidant may be more palatable to a pet than the same pet food or pet food ingredient containing a conventional antioxidant.

In one aspect, when the natural smoke antioxidant is used as the antioxidant during a rendering process, the resulting end products (rendered fats and animal protein meals) may have a pleasant odor. Thus, human perception (sensorial impacts) of the pet food may be improved and/or this may have a positive effect on pet food palatability.

In one aspect, when the natural smoke antioxidant is used as the antioxidant during a rendering process, the resulting animal meal may have roasted type flavor notes via Maillard reaction mechanisms. As a result, animal protein meals may have improved color and/or flavor profile. In addition, Maillard reaction products may provide some added antioxidant effects.

In one aspect, the natural smoke antioxidant may be added individually or in combination with conventional antioxidants to pet food or pet food ingredients such as fats, oils, vitamin premixes or rendered protein meals used to make pet food.

In one aspect, the natural smoke antioxidant may be used as a replacement for natural mixed tocopherols that are typically added to various rendered ingredients, such as animal protein meals and rendered fats, as well as animal feed and pet food.

In one aspect, the present disclosure provides a method of making pet food, which includes adding the natural smoke antioxidant to a raw material of the pet food. This is because the natural smoke antioxidant is effective to prevent rancidification of fats and oils. Thus, the natural smoke antioxidant can be used at various stages in the method of making pet food. This is in contrast to, for example, the conventional use of liquid, natural smoke flavor, wherein the liquid smoke would be added as a flavoring agent to the final product.

In one aspect, the natural smoke antioxidant may be used as a replacement for ethoxyquin in rendered ingredients, such as animal protein meals and rendered fats, as well as in animal feed and pet food products.

In one aspect, the natural smoke antioxidant may be used as a replacement for synthetic antioxidants, such as BHA, BHT, TBHQ, propyl gallate and ethoxyquin in rendered ingredients, such as animal protein meals and rendered fats, as well as in animal feed and pet food products.

In one aspect, the present disclosure provides for a process of feeding pets the pet food of the present disclosure (which also means, in the present disclosure, feeding any animal (such as livestock) an animal food having the natural smoke extract).

In one aspect, the natural smoke antioxidant may be in the form of a liquid. In some embodiments, the liquid natural smoke antioxidant may be provided in a sealed package or container for individual, commercial, or industrial sale. In some aspects, the contents of the sealed package may consist essentially of the liquid natural smoke antioxidant or may consist of the liquid smoke antioxidant. In other words, the present disclosure provides for a sealed package that may contain only or substantially only the liquid natural smoke antioxidant for downstream use.

In one aspect, the natural smoke antioxidant may be in a dry form (e.g., a dry form may be in the form of a powder or other free-flowing particulate, and may have a moisture content of less than 5% by weight). In some embodiments, the dry natural smoke antioxidant may be provided in a sealed package or container for individual, commercial, or industrial sale. In some aspects, the contents of the sealed package may consist essentially of the dry natural smoke antioxidant or may consist of the dry smoke antioxidant. In other words, the present disclosure provides for a sealed package that may contain only or substantially only the dry natural smoke antioxidant for downstream use.

In one aspect, the present disclosure provides a method of drying or otherwise reducing the moisture content of the natural smoke antioxidant to provide a dry natural smoke antioxidant.

In one aspect, the present disclosure provides a method of preserving a dry pet food kibble, the method including applying a coating composition including the natural smoke antioxidant, poultry fat, and optionally a palatant to a surface of the dry pet food kibble in an amount sufficient to provide antioxidant effect and without adversely affecting the palatability of the dry pet food kibble. In some aspects, the dry pet food kibble is intended to be packaged for sale and consumption by a cat or a dog, and may be labeled as such.

In the present disclosure, the term palatant is intended to refer to its known definition in the pet food art. Palatants may refer to ingredient systems that are specially designed to make pet foods, treats, and supplements taste better, and may ensure that pets receive the vital nutrients they need. Palatants may entice a pet to consume a food, treat, or supplement that, while nutritious, may be inconsistent with their native diet.

In one aspect, the present disclosure provides a composition including a palatant and the natural smoke antioxidant.

In one aspect, the present disclosure provides for a composition including the natural smoke extract and acetylated monoglycerides.

In one aspect, the present disclosure provides for a composition including the natural smoke extract, acetylated monoglycerides, and a vegetable oil (such as, for example, canola oil, soybean oil, sunflower oil or corn oil).

In one aspect, the present disclosure provides for a composition including the natural smoke extract, acetylated monoglycerides, and mixed tocopherols.

In one aspect, the present disclosure provides for a composition including the natural smoke extract, acetylated monoglycerides, mixed tocopherols, and a vegetable oil (such as, for example, a canola oil).

In one aspect, the present disclosure provides for a composition including the natural smoke extract and mixed tocopherols.

In one aspect, the present disclosure provides for a composition including the natural smoke extract and silicon dioxide.

In one aspect, the present disclosure provides for a composition including the natural smoke extract, acetylated monoglycerides, and silicon dioxide.

In one aspect, the present disclosure provides for a composition including the natural smoke extract and rosemary extract.

In one aspect, the present disclosure provides for a composition including the natural smoke extract and citric acid.

In one aspect, the present disclosure provides for a composition including the natural smoke extract and lemon juice concentrate.

In one aspect, the present disclosure provides for a composition including the natural smoke extract, rosemary extract, and citric acid extract.

In one aspect, the present disclosure provides for a composition including the natural smoke extract, acetylated monoglycerides, silicon dioxide, rosemary extract, and citric acid.

In one aspect, the present disclosure provides for a composition including the natural smoke extract, acetylated monoglycerides, rosemary extract, and citric acid.

In one aspect, the present disclosure provides for a composition including the natural smoke extract, acetylated monoglycerides, rosemary extract and green tea extract.

In one aspect, the present disclosure provides for a composition including the natural smoke extract and green tea extract or palmitoylated green tea extract catechins.

In one aspect, the present disclosure provides for a composition including the natural smoke extract and acerola extract.

In one aspect, the present disclosure provides for a composition including the natural smoke extract and spearmint extract.

In one aspect, the present disclosure provides for a composition including the natural smoke extract and citric acid esters of mono- and diglycerides.

In one aspect, the present disclosure provides for a composition including the natural smoke extract, acetylated monoglycerides, silicon dioxide, rosemary extract, green tea extract and citric acid.

In one aspect, the present disclosure provides for a composition including the natural smoke extract, acetylated monoglycerides, silicon dioxide, rosemary extract, acerola extract and citric acid.

In one aspect, the natural smoke antioxidant is compliant for use in animal food applications in the United States as a “natural flavor” as indicated in 21 C.F.R. § 502.22, which states that “The term natural flavor or natural flavoring means the essential oil, oleoresin, essence or extractive, protein hydrolysate, distillate, or any constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional.”

Additional features and advantages of the present disclosure are described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### DRAWINGS

The patent or application file contains at least one drawing executed in color. Copies of this patent or application publication with color drawing(s) will be provided by the Office upon request and payment of the necessary fee. The foregoing summary, as well as the following detailed description of certain embodiments of the application, will be better understood when read in conjunction with the appended drawings. In the drawings:

FIGS. 1-39 illustrate, show, and/or include the results and design of the Example embodiments.

FIGS. 1-9 show results of Example 1, wherein:

FIG. 1 shows a protection factor of poultry fat using various antioxidants.

FIG. 2 shows a protection factor of canola oil using various antioxidants.

FIG. 3 shows a protection factor of sunflower oil using various antioxidants.

FIG. 4 shows a protection factor of poultry fat using various antioxidants.

FIG. 5 shows oxidative by-products formed during 10 week storage of chicken fat at 40° C.

FIG.6 shows oxidative by-products formed during 12 week storage of chicken fat at 40° C.

FIG. 7 shows oxidative by-products formed during 10 week storage of choice white grease at 40° C.

FIG. 8 shows peroxide values of chicken meal during 8 week storage at various temperatures.

FIG. 9 shows oxidative by-products formed during 8 week storage of poultry meal at 40° C.

FIG. 10 shows oxidative by-products formed during 8 week storage of meat and bone meal at 40° C.

FIG. 11 shows oxidative by-products formed during 10 week storage of chicken fat at 40° C.

FIG. 12 shows a comparison of batch 1 versus batch 2 in Example 2.

FIG. 13 shows a consumption summary of batch 1 versus batch 2 in Example 2.

FIG. 14 shows preference by intake ratio of batch 1 versus batch 2 in Example 2.

FIG. 15 shows preference by first choice of batch 1 versus batch 2 in Example 2.

FIG. 16 shows a comparison of batch 1 versus batch 4 in Example 2.

FIG. 17 shows a consumption summary of batch 1 versus batch 4 in Example 2.

FIG. 18 shows preference by intake ratio of batch 1 versus batch 4 in Example 2.

FIG. 19 shows preference by first choice of batch 1 versus batch 4 in Example 2.

FIG. 20 shows a comparison of batch 2 versus batch 3 in Example 2.

FIG. 21 shows a consumption summary of batch 2 versus batch 3 in Example 2.

FIG. 22 shows preference by intake ratio of batch 2 versus batch 3 in Example 2.

FIG. 23 shows preference by first choice of batch 2 versus batch 3 in Example 2.

FIG. 24 shows a comparison of batch 4 versus batch 5 in Example 2.

FIG. 25 shows a consumption summary of batch 4 versus batch 5 in Example 2.

FIG. 26 shows preference by intake ratio of batch 4 versus batch 5 in Example 2.

FIG. 27 shows preference by first choice of batch 4 versus batch 5 in Example 2.

FIG. 28 shows peroxide values of kibbles stored at 25° C. in Example 3.

FIG. 29 shows hexanal contents of kibbles stored at 25° C. in Example 3.

FIG. 30 shows polycyclic aromatic hydrocarbons (PAHs) in kibbles in Example 3.

FIG. 31 shows a methodology of the investigation of Example 5 comparing kibbles with and without smoke in consumer testing.

FIG. 32 shows preference results for Example 5.

FIG. 33 shows liking results for Example 5.

FIG. 34 shows a penalty analysis interpretation for Example 5.

FIG. 35 shows a penalty analysis and JAR distributions for the original (no smoke) kibbles in Example 5.

FIG. 36 shows a penalty analysis and JAR distributions for the 0.2% smoke kibbles in Example 5.

FIG. 37 shows emotional descriptions for Example 5.

FIG. 38 shows likes and dislikes for the original (no smoke) kibbles in Example 5.

FIG. 39 shows likes and dislikes for the 0.2% smoke kibbles in Example 5.

### DETAILED DESCRIPTION OF THE DISCLOSURE

Before the present compositions, methods, and methodologies are described in more detail, it is to be understood that the disclosure is not limited to particular compositions, methods, and experimental conditions described, as such compositions, methods, and conditions may vary. It is also to be understood that the terminology used herein is for purposes of describing particular embodiments only, and is not intended to be limiting, since scope will be limited only in the appended claims

The detailed description of the disclosure corresponds to the summary of the disclosure, the drawings, and the following examples and is not repeated here.

### EXAMPLES

In the following, although embodiments of the present disclosure are described in further detail by means of Examples, the present disclosure is not limited thereto.

### Example 1

Various tests were designed and performed to test the following compositions containing the natural smoke extract of the present disclosure as compared, for example, to conventional techniques/products:

NaSure 600 Liquid—Acetylated Monoglycerides, Natural Smoke Flavor (i.e., the natural smoke extract).

NaSure 651 Liquid—Acetylated Monoglycerides, Canola Oil, Mixed Tocopherols, Natural Smoke Flavor

NaSure 661 Dry—Acetylated Monoglycerides, Silicon Dioxide, Natural Smoke Flavor

NaSure 662 Dry—Acetylated Monoglycerides, Silicon Dioxide, Rosemary Extract, Citric Acid, Natural Smoke Flavor

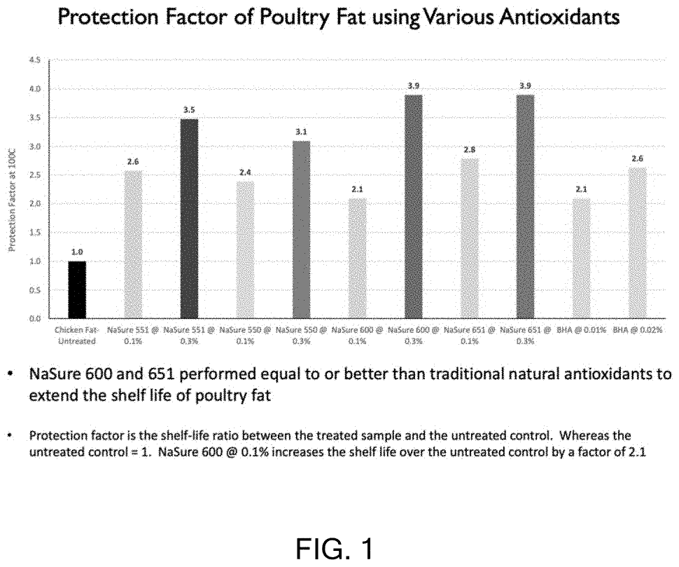

The results are shown in FIGS. 1-11 and are discussed in more detail below relative to each figure.

Referring to FIG. 1, NaSure 551 and NaSure 550 are commercially available natural antioxidants comprised of mixed tocopherols and rosemary extract from Camlin Fine Sciences, Ltd. The chart in FIG. 1 shows oxidative stability of chicken fat, measured with an Oxidative Stability Index as per AOCS Official Method Cd 12b-92.

In order to evaluate the effectiveness of natural smoke flavor, this test was performed to compare oxidative stability versus common antioxidants used in petfood or petfood ingredients. The results in FIG. 1 show that NaSure 600 increased the shelf life of poultry fat over the untreated control and worked equal to or better than the other common antioxidants at same or typical industry standard application rates.

The protection factor is the shelf-life ratio between the treated sample and the untreated control, whereas the untreated control=1. As shown NaSure 600 at 0.1% increased the shelf life over the untreated control by a factor of 2.1.

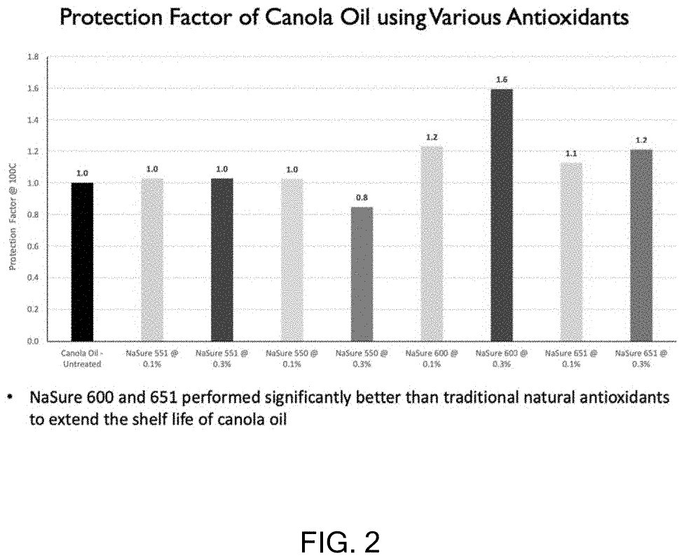

Referring to FIG. 2, NaSure 551 and NaSure 550 are commercially available natural antioxidants comprised of mixed tocopherols and rosemary extract from Camlin Fine Sciences, Ltd. The chart in FIG. 2 shows oxidative stability of canola oil, measured with an Oxidative Stability Index as per AOCS Official Method Cd 12b-92.

In order to evaluate the effectiveness of natural smoke flavor, this test was performed to compare oxidative stability versus common antioxidants used in petfood or petfood ingredients. The results in FIG. 2 show that NaSure 600 increased the shelf life of canola oil versus the untreated control and worked equal to or better than the other common antioxidants at same or typical industry standard application rates.

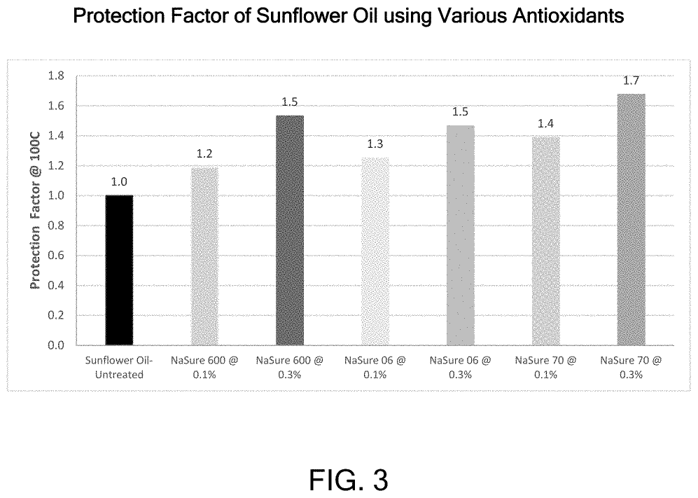

Referring to FIG. 3, NaSure 06 is a commercially available natural antioxidant comprised of liquid rosemary extract from Camlin Fine Sciences, Ltd., and NaSure 70 is a commercially available natural antioxidant comprised of mixed tocopherols from Camlin Fine Sciences, Ltd. The chart in FIG. 3 shows oxidative stability of sunflower oil, measured with an Oxidative Stability Index as per AOCS Official Method Cd 12b-92.

In order to evaluate the effectiveness of natural smoke flavor, this test was performed to compare oxidative stability versus common antioxidants used in petfood or petfood ingredients. The results in FIG. 3 show that NaSure 600 increased the shelf life of sunflower oil versus the untreated control and worked somewhat similar to the other common antioxidants at same or typical industry standard application rates.

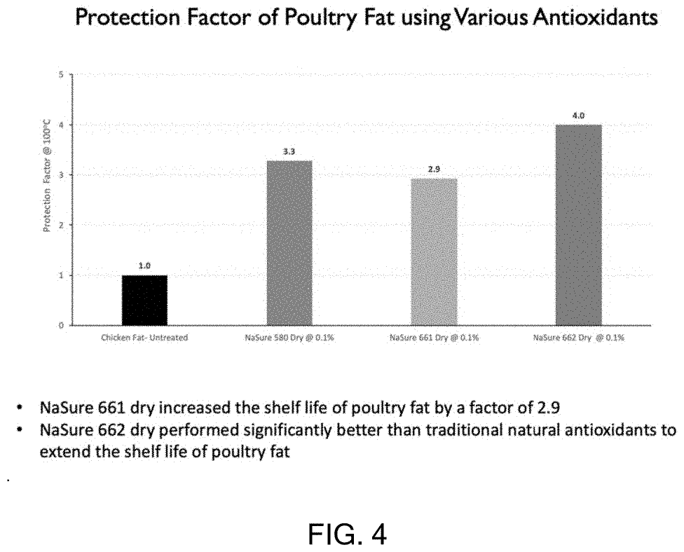

Referring to FIG. 4, NaSure 580 is a commercially available dry natural antioxidant comprised of mixed tocopherols and rosemary extract on a dry carrier from Camlin Fine Sciences, Ltd. The chart in FIG. 4 shows oxidative stability of poultry fat, measured with an Oxidative Stability Index as per AOCS Official Method Cd 12b-92.

In order to evaluate the effectiveness of natural smoke flavor, this test was performed to compare oxidative stability versus common antioxidants used in petfood or petfood ingredients. The results show that NaSure 661 & NaSure 662 increased the shelf life of poultry fat versus the untreated control and worked equal to or better than the other common antioxidants at same or typical industry standard application rates.

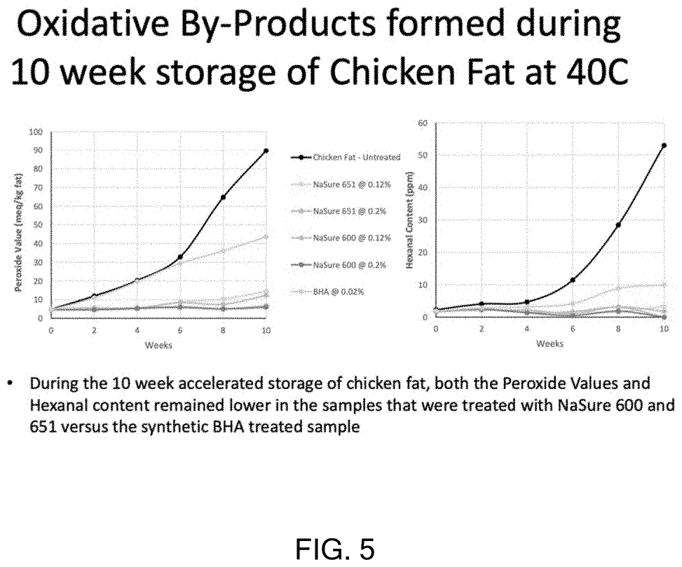

Referring to FIG. 5, this chart shows the formation of oxidative by-products over time in chicken fat. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performed to compare the inhibition of hydroperoxides and hexanal formation versus common antioxidants used in petfood or petfood ingredients. The results show that NaSure 600 delayed oxidative by-product formation versus untreated control and worked equal to or better than the other common antioxidants at same or typical industry standard application rates.

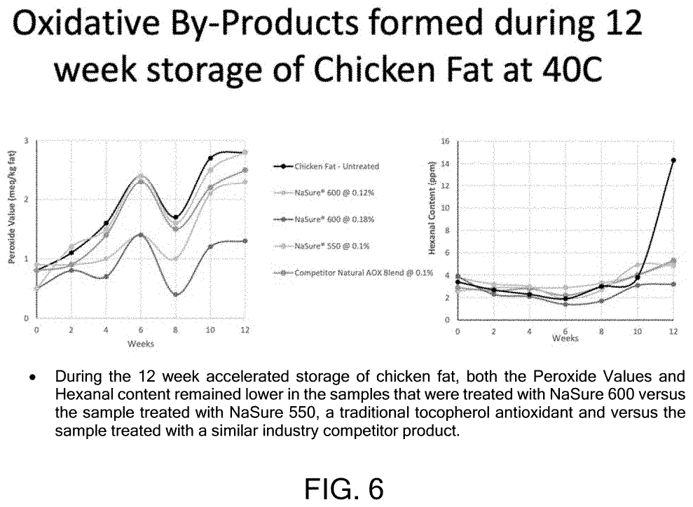

Referring to FIG. 6, NaSure 550 is a commercially available natural antioxidant comprised of mixed tocopherols and rosemary extract from Camlin Fine Sciences, Ltd. The chart in FIG. 6 shows the formation of oxidative by-products over time in chicken fat. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performd to compare hydroperoxides and hexanal formation versus common antioxidants used in petfood or petfood ingredients. The results show that NaSure 600 delayed oxidative by-product formation versus untreated control and worked equal to or better than the other common antioxidants at same or typical industry standard application rates.

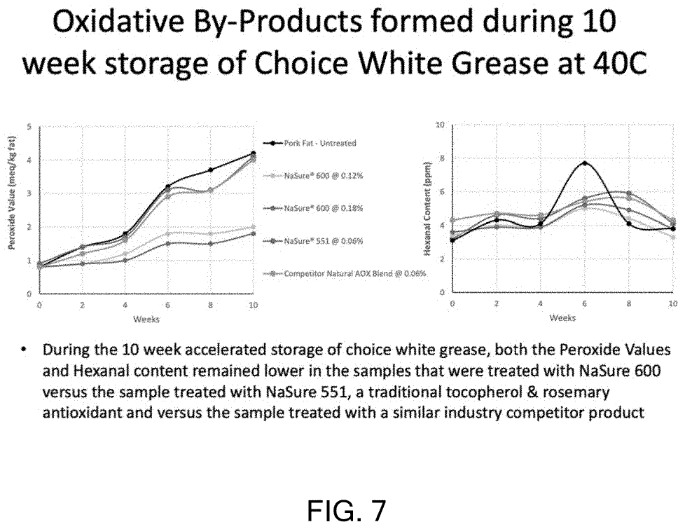

Referring to FIG. 7, NaSure 551 is a commercially available natural antioxidant comprised of mixed tocopherols and rosemary extract from Camlin Fine Sciences, Ltd. The chart in FIG. 7 shows the formation of oxidative by-products over time in choice white grease. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performed to compare hydroperoxides and hexanal formation versus common antioxidants used in petfood or petfood ingredients. The results show that NaSure 600 delayed oxidative by-product formation versus untreated control and works equal to or better than the other common antioxidants at same or typical industry standard application rates.

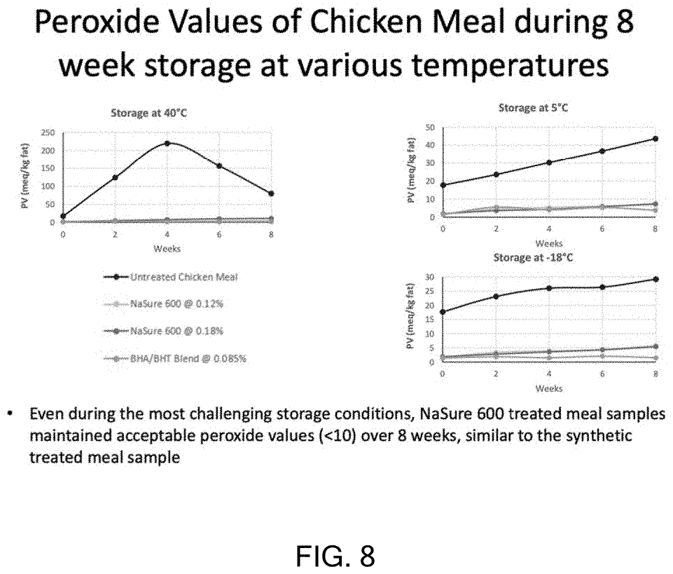

Referring to FIG. 8, this chart shows the formation of oxidative by-products over time in chicken meal. Peroxide values were measured as per AOCS Official Method Cd 12-57. In order to evaluate the effectiveness of natural smoke flavor at delaying oxidative by-products from forming, these tests were performed to compare hydroperoxides formation versus common synthetic antioxidants used in petfood or petfood ingredients. The results show that NaSure 600 delayed oxidative by-product formation versus untreated control and worked equal to or better than the other common synthetic antioxidants at same or typical industry standard application rates

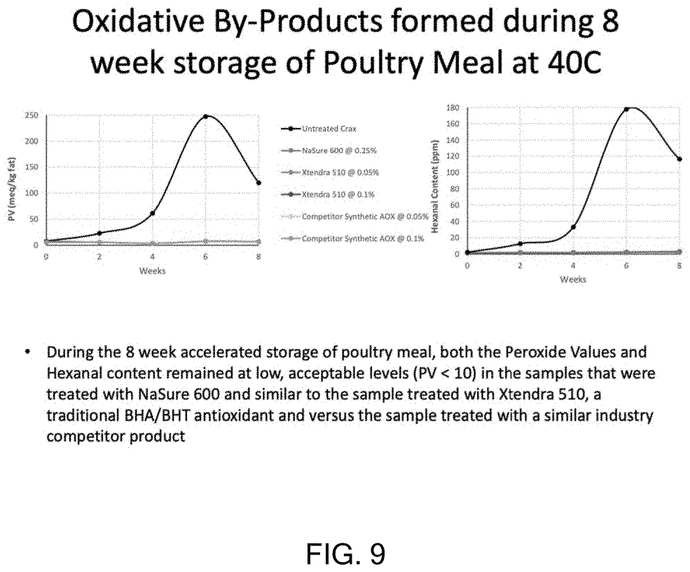

Referring to FIG. 9, Xtendra 510 is a commercially available synthetic antioxidant blend comprised of BHA and BHT in a vegetable oil carrier from Camlin Fine Sciences, Ltd. The chart in FIG. 9 shows the formation of oxidative by-products over time in poultry meal. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performed to compare hydroperoxides and hexanal formation versus common antioxidants used in petfood or petfood ingredients. The results show that NaSure 600 delayed oxidative by-product formation versus untreated control and worked equal to or better than the other common antioxidants at same or typical industry standard application rates.

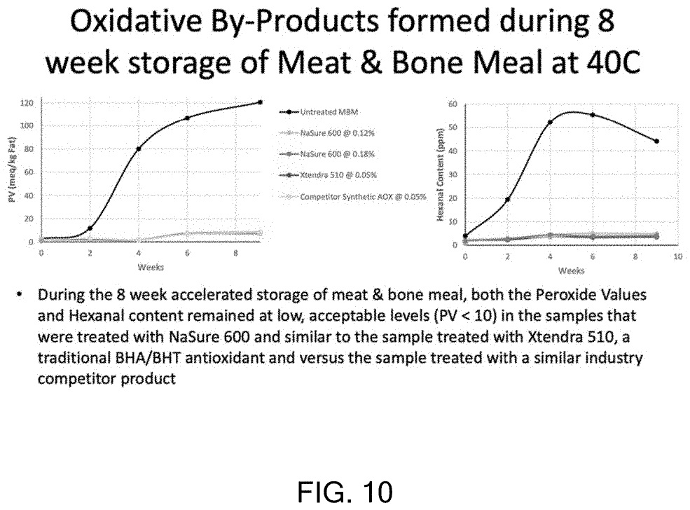

Referring to FIG. 10, Xtendra 510 is a commercially available synthetic antioxidant blend comprised of BHA and BHT in a vegetable oil carrier from Camlin Fine Sciences, Ltd. The chart in FIG. 10 shows the formation of oxidative by-products over time in beef meat and bone meal. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performed to compare hydroperoxides and hexanal formation versus common antioxidants used in petfood or petfood ingredients. The results show that NaSure 600 delayed oxidative by-product formation versus untreated control and worked equal to or better than the other common antioxidants at same or typical industry standard application rates.

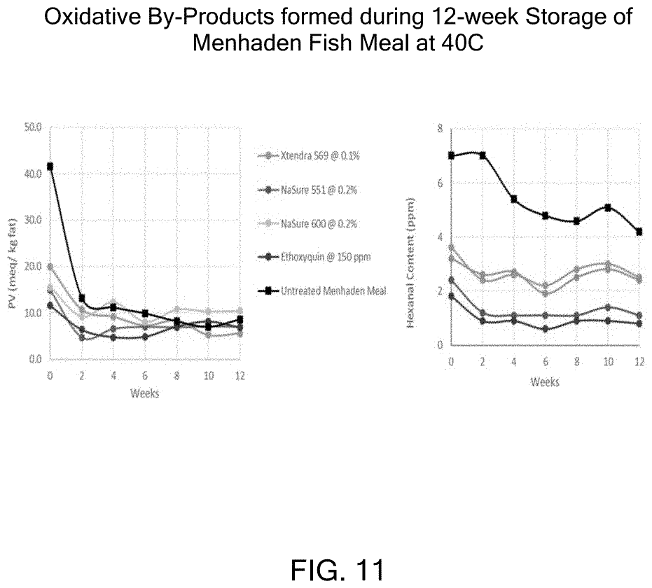

Referring to FIG. 11, Xtendra 569 is a commercially available synthetic antioxidant comprised of BHT in a vegetable oil carrier from Camlin Fine Sciences, Ltd., and NaSure 551 is a commercially available natural antioxidant comprised of mixed tocopherols and rosemary extract from Camlin Fine Sciences, Ltd. The chart in FIG. 11 shows the formation of oxidative by-products over time in menhaden fish meal. Peroxide values were measured as per AOCS Official Method Cd 12-57. Hexanal contents were measured using Agilent Technologies 7820A gas chromatograph coupled with Agilent Technologies 7697A static headspace sampler using a proprietary methodology.

In order to evaluate the effectiveness of natural smoke flavor at delaying oxidative by-products from forming, these tests were performed to compare the inhibition of hydroperoxides and hexanal formation versus common antioxidants used in finished petfood, petfood ingredients or aqua feed ingredients. The results show that NaSure 600 delayed oxidative by-product formation versus untreated control and had comparable performance to the other common antioxidants at same or typical industry standard application rates.

### Example 2

Palatability was evaluated using NaSure 600 compared to competitor product according to the following.

Five test diets were prepared per Table 1 below:

| | | | | Liver |
|---|---|---|---|---|
| | Poultry Meal | Base Flour Meal | Fat | Palatant |
| Batch | (36.9%) | (55.5%) | (6.4.%) | (1.2%) |
| 1 | Antioxidant Blend A* @ | Antioxidant Blend A* @ 250 ppm | Antioxidant Blend A* @ | Yes |
| | 1200 ppm | | 1200 ppm | |
| 2 | NaSure 600 @ 2500 ppm | Antioxidant Blend A* @250 ppm | Antioxidant Blend A* @ | Yes |
| | | | 1200 ppm | |
| 3 | NaSure 600 @ 2500 ppm | NaSure 600 @ 1000 ppm | Antioxidant Blend A* @ | Yes |
| | | | 1200 ppm | |
| 4 | NaSure 600 @ 2500 ppm | NaSure 600 @ 1000 ppm | NaSure 600 @ 1800 ppm | Yes |
| 5 | NaSure 600 @ 2500 ppm | NaSure 600 @ 1000 ppm | NaSure 600 @ 1800 ppm | No |

*Antioxidant Blend A = Commercial Mixed Tocopherols and Rosemary Extract Blend

The palatability study was evaluated at Summit Ridge Farms.

The kennel facility is registered with the USDA. The kennel had a 12-hour-light/12-hour-dark cycle. Every attempt was made to keep temperature ranges within targeted conditions (from about 50° to about 85° F.). Cages and feed bowls were cleaned daily and sanitized. All in accordance with the Animal Welfare Act.

Twenty male and female Beagles identified by ear tattoo and cage number were presented the test diets on an individual basis. Two stainless steel bowls, each containing approximately 400 grams of diet, were offered once daily for 2 days. Bowl placement was reversed daily and both bowls were presented for 30 minutes. If one diet was completely consumed prior to the end of the 30 minutes, both bowls were removed. Food consumption and first choice preference were recorded for each dog.

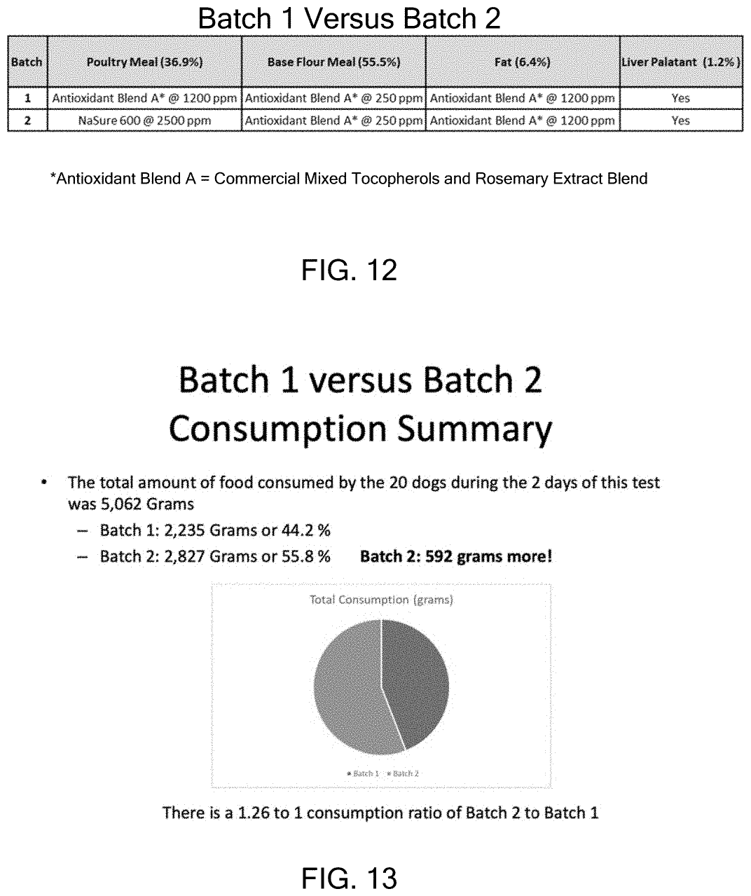

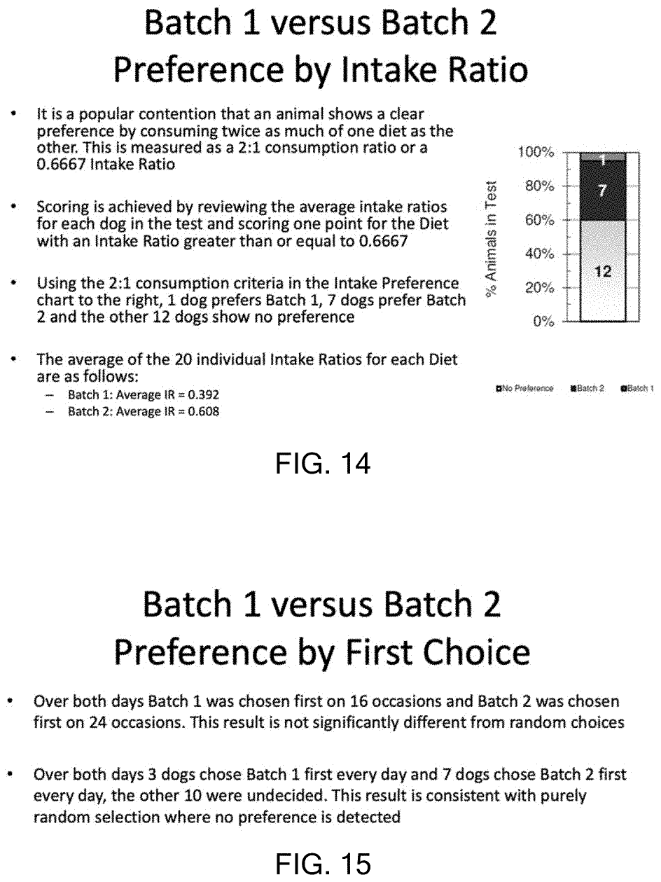

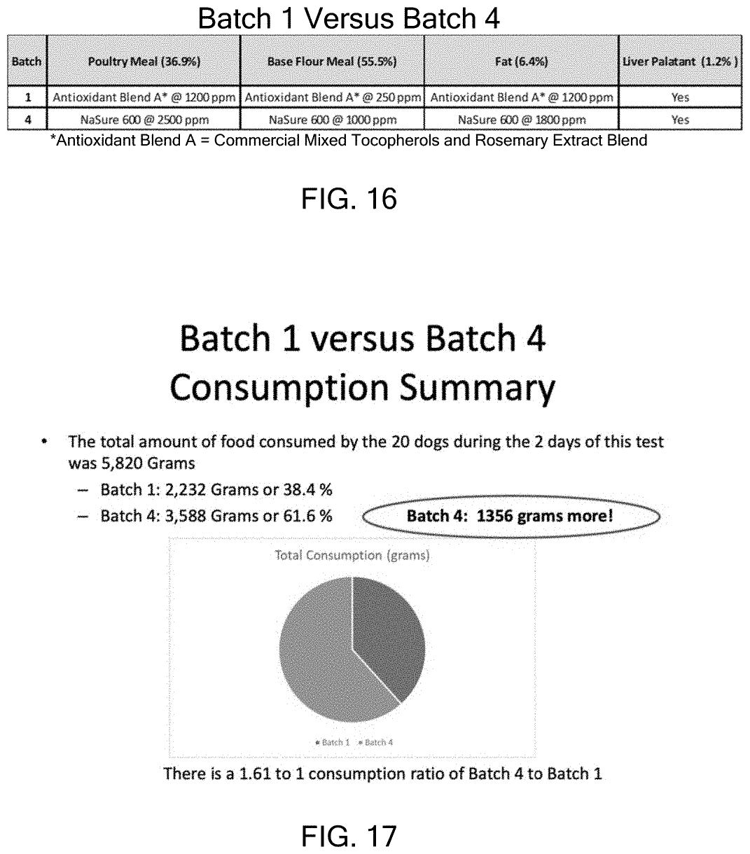

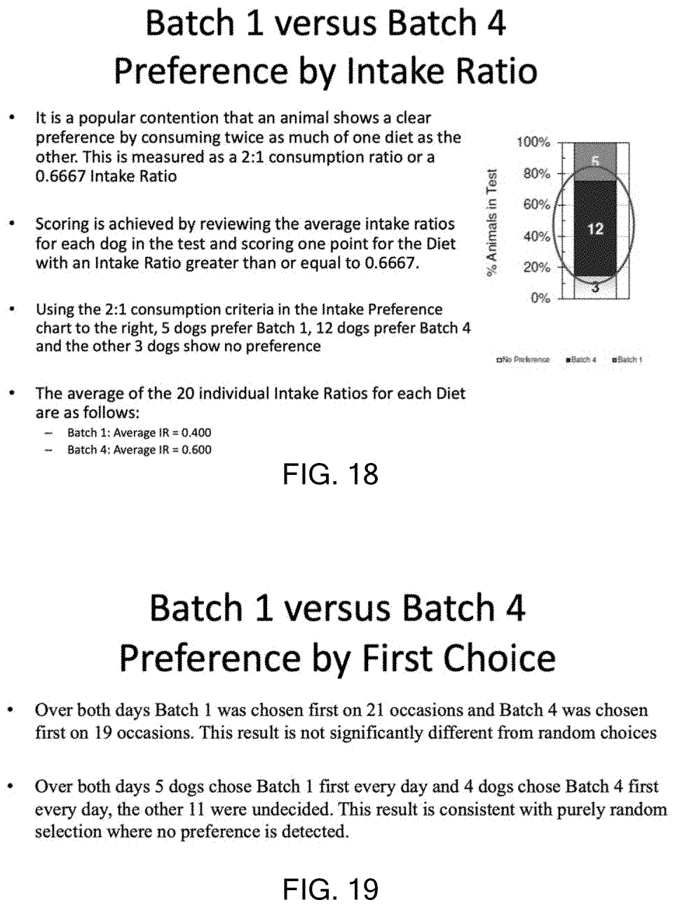

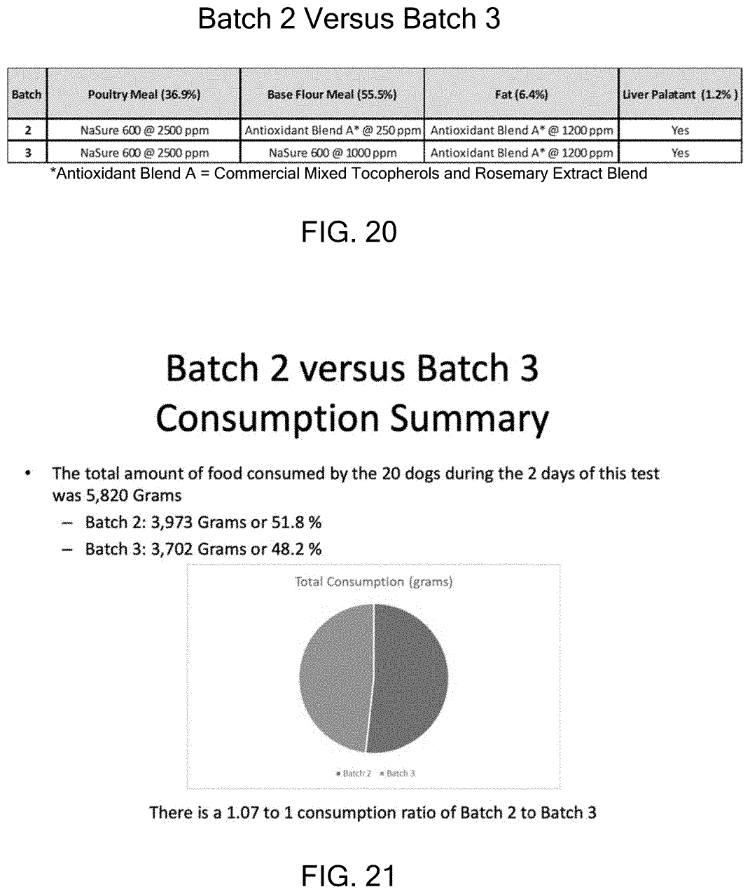

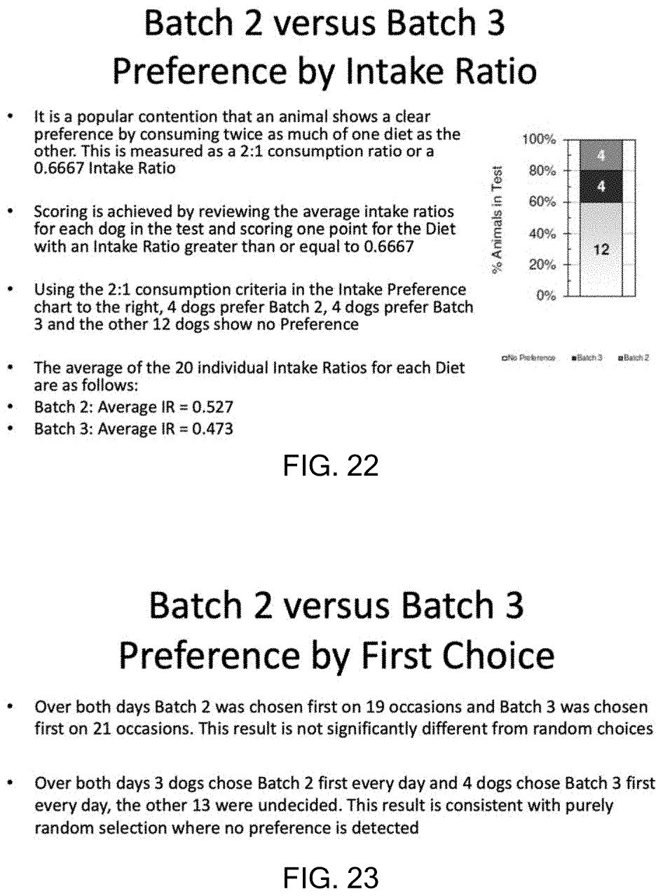

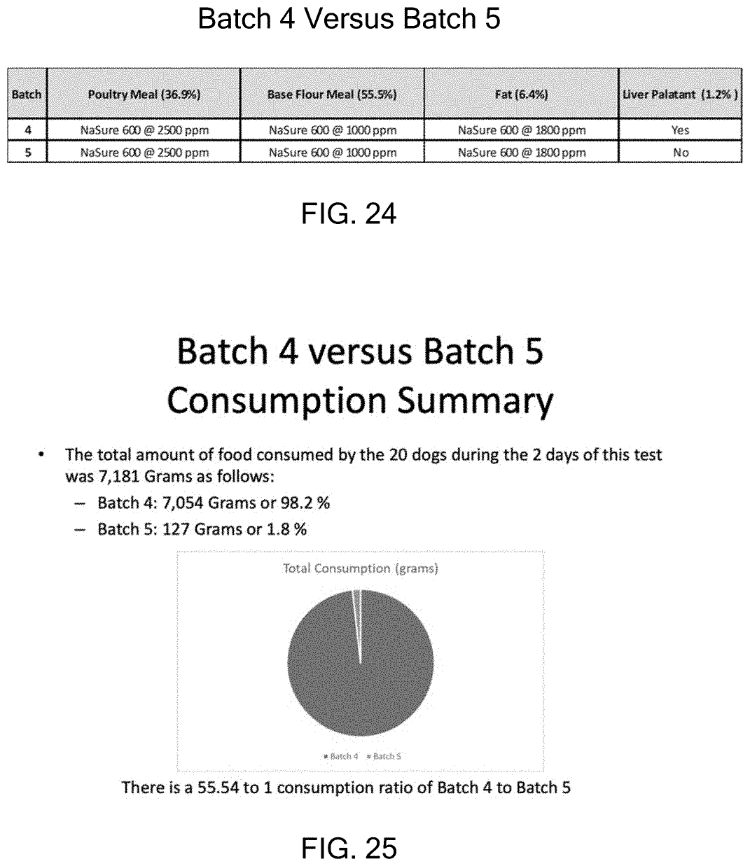

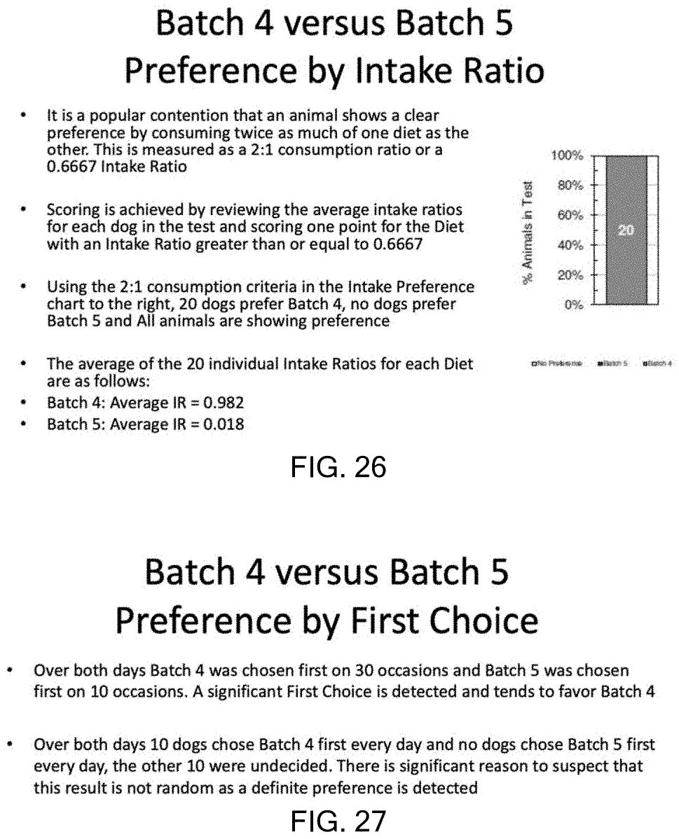

The results of the palatability tests are shown in FIGS. 12-27.

### Example 3

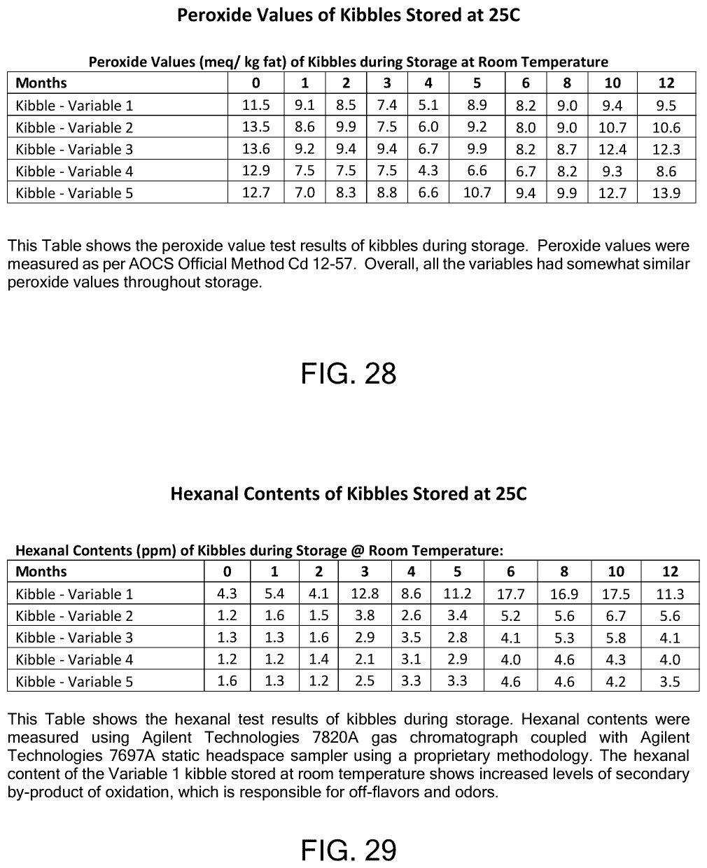

Oxidative stability was tested for Extru-Tech kibble, and the composition and results of this study are presented in FIGS. 28 and 29.

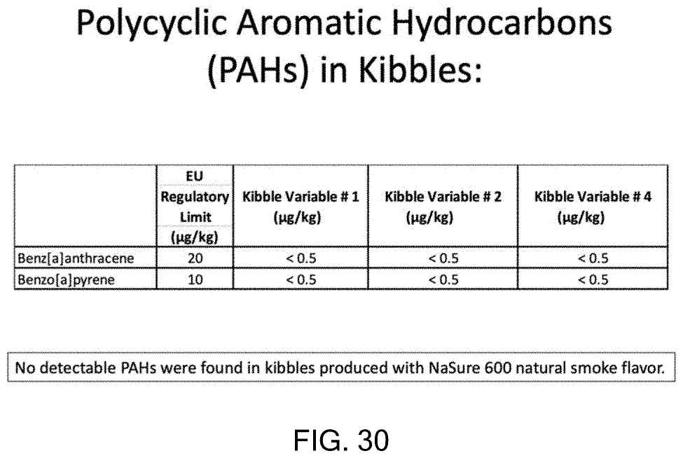

The kibble produced for Example 3 was also cited for polycyclic aromatic hydrocarbons (PAHs) in the kibbles. The results are shown in FIGS. 30.

### Example 4

People are projecting their personal tastes onto their pets, fueling growth in the premium pet food segment and the overall pet food category.

A survey of pet owners conducted by the Michelson Found Animals Foundation showed that 70% of people who follow a specialized diet for themselves have also put their pet on a special diet. At the same time, pet owners are increasingly seeking out (and are willing to pay a premium price for) sustainable pet food ingredients, operations, and packaging as consumers as a whole embrace environmental, social, and governance efforts.

For Example 4, a human sensory panel of 26 participants received 150 gram samples of finished dog kibble, where one was treated with traditional antioxidants for shelf life extension and the other was treated with NaSure 600 natural smoke flavor. The full results show that samples treated with NaSure 600 were found to be preferable to the sample treated with traditional antioxidants.

### Example 5

Example 5 was conducted to investigate hedonic response and perception of kibbles with and without smoke in a consumer test setting.

| | |
|---|---|
| Samples | Sample Name |

Original (No Smoke)
0.2% Smoke

Results: Under the conditions of this study:

The 0.2% natural smoke extract sample was liked significantly more overall when compared to the original (no smoke) sample. This sample also showed trending more aroma liking as well.

Just About Right (JAR) ratings suggested that: (a) the original sample without the natural smoke extract was perceived too low in smokey, meaty, fatty, and roasted aroma, while too high in grainy; and (b) the 0.2% natural smoke extract sample was perceived too high in roasted and smokey aroma.

The 0.2% natural smoke extract sample was significantly preferred over the original (no smoke) sample.

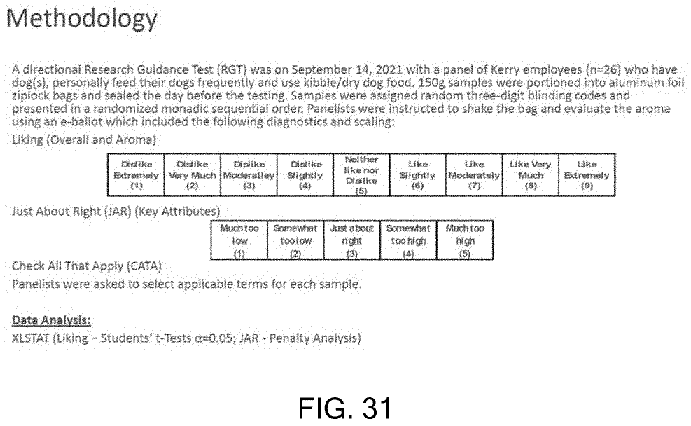

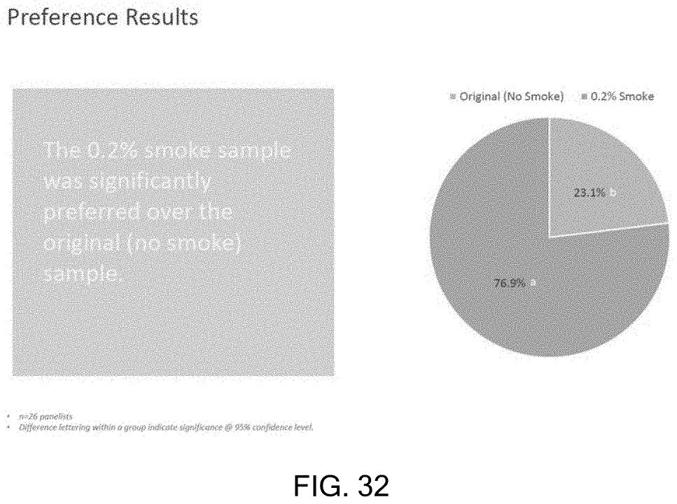

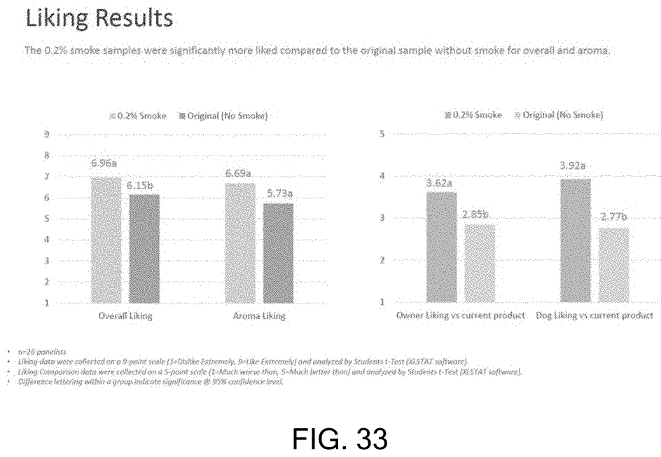

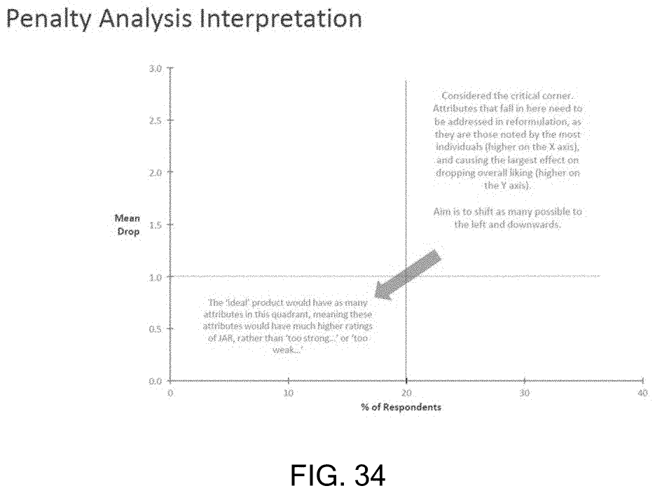

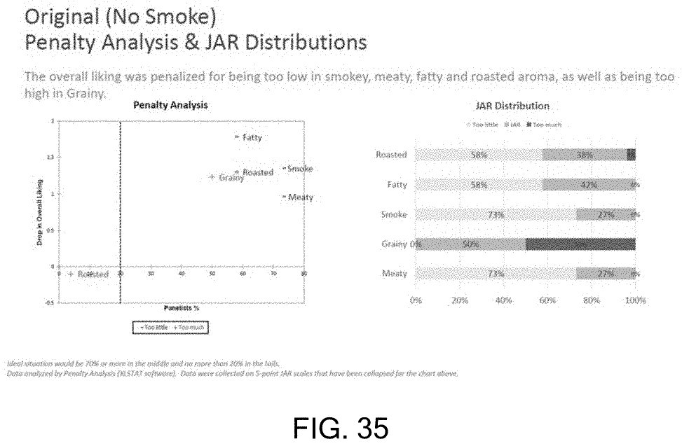

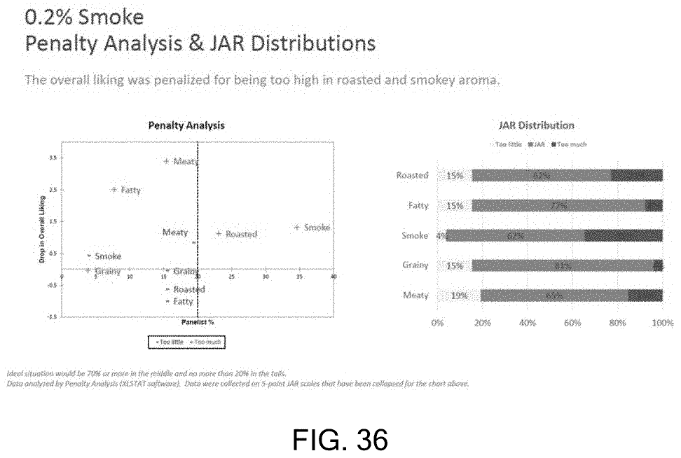

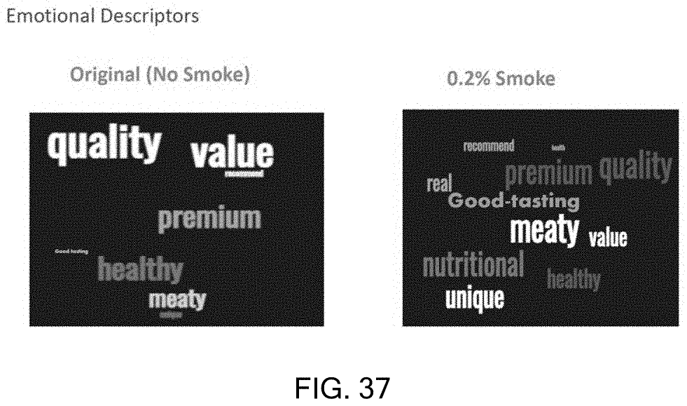

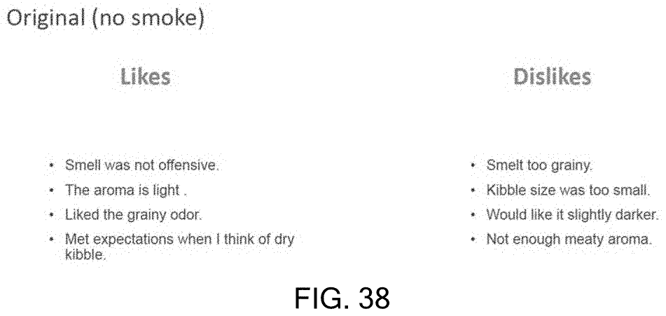

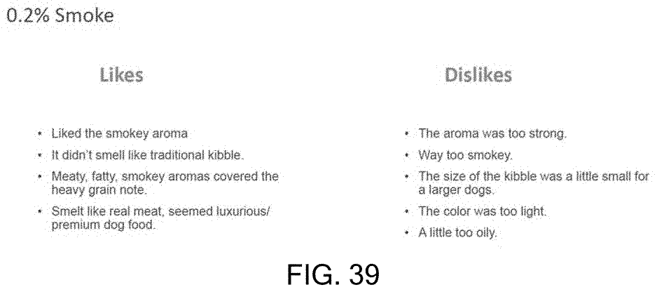

Specific results and methodologies are presented in FIGS. 31-39.

Additional features and advantages of the present disclosure are described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

1. A natural smoke antioxidant for pet food or a pet food ingredient, the natural smoke antioxidant comprising:
a phenolic extract obtained from liquid natural smoke,
wherein the phenolic extract has a function of delaying oxidation or hydrolysis of fats and oils in the pet food or pet food ingredient.

2. A pet food or pet food ingredient, comprising:
a natural smoke antioxidant comprising a phenolic extract obtained from liquid natural smoke,
wherein the phenolic extract is present in the pet food or pet food ingredient in an amount sufficient to delay oxidation or hydrolysis of fats and oils in the pet food or pet food ingredient.

3. The pet food or pet food ingredient according to claim 2, wherein
wherein the amount of the phenolic extract is sufficient to delay the oxidation or hydrolysis of the fats and oils in the pet food or pet food ingredient in the absence of any other antioxidant.

4. The pet food or pet food ingredient according to claim 2, wherein
wherein the amount of the phenolic extract is about 0.001% by weight to about 2% by weight based on a total weight of the pet food or pet food ingredient.

5. The pet food or pet food ingredient according to claim 2, wherein
wherein the amount of the phenolic extract in the pet food or pet food ingredient is about 200 ppm to 5000 ppm.

6. The pet food or pet food ingredient according to claim 2, wherein
the pet food or pet food ingredient is selected from the group consisting of fats rendered from animal protein, vegetable oils, animal protein meals, pet food kibbles, pet treats, palatants, vitamin & trace mineral pre-mixes, animal feed, and aqua feed.

7. The pet food or pet food ingredient according to claim 6, wherein
the pet food or pet food ingredient is the fats rendered from animal protein or the animal protein meal, and
the animal protein is one or more selected from the group consisting of pork, veal, lamb, chicken, turkey, beef, and fish.

8. A method of reducing oxidation of pet food or a pet food ingredient, the method comprising:
adding the natural smoke antioxidant according to claim 1 to the pet food or pet food ingredient.

9. The natural smoke extract according to claim 1, wherein
the liquid smoke is a composition obtained from the pyrolysis of biomass, and
the phenolic fraction is separated from the liquid smoke.

10. The natural smoke extract according to claim 1, wherein
the natural smoke extract is oil, lipid, or fat soluble.

11. A natural smoke antioxidant, comprising:
the natural smoke extract according to claim 1, and
one or more of additional components selected from the group consisting of mixed tocopherols, rosemary extract, green tea extract, palmitoylated green tea extract catechins, acerola cherry extract, spearmint extract, grapeseed extract, lemon balm extract, chamomile extract, acetylated monoglycerides, vegetable oil, silicon dioxide, and citric acid or citric acid esters of mono and diglycerides.

12. The pet food or pet food ingredient according to claim 2, wherein
the pet food or pet food ingredient does not contain any one of BHA, BHT, TBHQ, propyl gallate, ascorbyl palmitate, ethoxyquin, rosemary extract, sage extract, green tea extract, acerola extract, lemon balm extract, grapeseed extract, sage extract, or mixed tocopherols.

13. A rendering process, comprising:
adding the natural smoke extract according to claim 1 to animal tissue to prepare pet food or a pet food ingredient.

14. The rendering process according to claim 13, wherein
the natural smoke extract is added in an amount sufficient to delay oxidation or hydrolysis of fats in animal tissue.

15. The rendering process according to claim 14, wherein
mixed tocopherols are not added to the animal tissue during the rendering process.

16. A method of making pet food or petfood ingredient, the method comprising:
adding the natural smoke extract according to claim 1 to a raw material for making pet food in an amount sufficient to delay oxidation or hydrolysis of fats and oils in the raw material.

17. A method of feeding an animal, comprising:
feeding the animal the pet food or pet food ingredient according to claim 2.

18. (canceled)

19. A natural smoke antioxidant, comprising:
the natural smoke extract according to claim 1, wherein
the natural smoke antioxidant is in the form of a dry powder.

20. A method of preserving a dry pet food kibble, the method comprising:
applying a coating composition including the natural smoke extract according to claim 1, poultry fat, and optionally a palatant to a surface of the dry pet food kibble in an amount sufficient to provide antioxidant effect and without adversely affecting the palatability of the dry pet food kibble.

21.-38. (canceled)

39. The natural smoke extract according to claim 1, wherein the natural smoke extract comprises 5 to 50 mg/ml of the phenolic extract.

40.-43. (canceled)
